(19) United States
(12) Patent Application Publication
(10) Pub. No.: US 2025/0155395 A1
(43) Pub. Date: May 15, 2025

(54) METHOD FOR OPERATING A TDR LEVEL MEASURING DEVICE AND TDR LEVEL MEASURING DEVICE

(71) Applicant: KROHNE S.A.S., Romans-sur-Isère Cedex (FR)

(72) Inventors: Samuel GROSDIDIER, Beauregard Baret (FR); Fabrice MARCEL, Saint Peray (FR)

(73) Assignee: KROHNE S.A.S., Romans-sur-Isère Cedex (FR)

(21) Appl. No.: 18/944,869

(22) Filed: Nov. 12, 2024

(30) Foreign Application Priority Data
Nov. 9, 2023 (DE) 10 2023 131 085.2

(51) Int. Cl. G01N 27/02

(52) U.S. Cl. CPC G01N 27/028

(57) ABSTRACT

A method for operating a TDR level measuring device that has at least one probe for guiding an electromagnetic signal and a measuring transducer. The measuring transducer comprises an electronic unit for generating a measuring signal and for evaluating a reflected measuring signal and a process connection element. The measuring transducer is connected to a container via the process connection element, and a process medium to be measured is arranged in the container. A gaseous medium is arranged above the process medium. A relative permittivity of the gaseous medium is determined by capturing and evaluating the amplitude of a measuring signal emitted by the electronics unit and the amplitude of a measuring signal reflected at the interface of the process connection element and the container. In order to determine the relative permittivity, the attenuation of the emitted measuring signal by the measuring transducer is taken into account.

This nonprovisional application claims priority under 35 U.S.C. § 119(a) to German Patent Application No. 10 2023 131 085.2, which was filed in Germany on Nov. 9, 2023, and which is herein incorporated by reference.

### BACKGROUND OF THE INVENTION

### Field of the Invention

The invention is based on a method for operating a TDR level measuring device, wherein the TDR level measuring device comprises at least one probe for guiding an electromagnetic signal and a measuring transducer, wherein the measuring transducer comprises an electronic unit for generating a measuring signal and for evaluating a reflected measuring signal, and a process connection element, wherein the measuring transducer is connected to a container via the process connection element, wherein process medium to be measured is arranged in the container, and wherein a gaseous medium is arranged above the process medium, wherein the relative permittivity εᵣ of the gaseous medium is determined by means of capturing and evaluating the amplitude A_{S} of a measuring signal emitted by the electronic unit and the amplitude A_{R} of a measuring signal reflected at the interface of the process connection element and the container.

Furthermore, the invention relates to a TDR level measuring device with at least one probe for guiding an electromagnetic signal and with a measuring transducer, wherein the measuring transducer comprises an electronic unit for generating a measuring signal and for evaluating a reflected measuring signal, and a process connection element, wherein the measuring transducer can be connected to a container via the process connection element.

### Description of the Background Art

TDR level measuring devices for measuring the fill level of a process medium arranged in a vessel are known from the prior art.

Known TDR level measuring devices are based on the transit time measurement of a measuring signal, which is guided via the probe in the direction of the process medium and reflected at the interface to the process medium. From the transit time, the distance between the process connection, which is usually designed as a flange, and the process medium surface, and thus the fill level in the container, can be determined.

To improve the accuracy of the transit time measurement and in this respect to optimize level determination, the knowledge of the propagation speed of the measuring signal moving along the probe is of crucial im-portance. If the gaseous medium arranged above the process medium is different from air, this also influences the propagation speed of the measuring signal moving along the probe through the gaseous medium.

It is known from the prior art DE 10 2017 108 702 A1, which corresponds to US 2018/0306632, which is incorporated herein by reference, to determine the relative permittivity εᵣ of a gaseous medium arranged above the process medium.

### SUMMARY OF THE INVENTION

It is therefore an object of the invention to provide a method for operating a TDR level measuring device that improves transit time determination. In addition, it is an object of the invention to disclose a corresponding TDR level measuring device for performing the method according to the invention.

According to an example of the present invention, the aforementioned object is achieved by a method described, in that for determining the relative permittivity εᵣ, the attenuation α₀ of the emitted measuring signal by the measuring transducer is taken into account, wherein for determining the attenuation α₀, the attenuation de by the electronic unit and the mechanical attenuation am by the process connection element are determined, and/or that the impedance ratio IFR₀=Z_{0_probe}/Z_{MU} is taken into account for determining the relative permittivity εᵣ, wherein Z_{0_probe} is the impedance of the probe in vacuum and Z_{MU} is the impedance of the measuring transducer, and wherein the impedance ratio IFR₀ is determined in a reference gas with known permittivity εᵣ.

The determination of the attenuation α₀ of the measuring signal in the measuring transducer is divided into the determination of the attenuation αₑ by the electronic unit and the mechanical attenuation αₘ by the process connection element.

This procedure represents a simple way of determining the total attenuation α₀ of the measuring signal by the measuring transducer.

The attenuation αₑ is measured, wherein a reflector element, for example a resistor, a short circuit or an open end, can be placed at the output of the electronic unit to measure the attenuation αₑ, and wherein αₑ is determined by comparing the amplitude of a measuring signal A_{eS} emitted by the electronic unit and a measuring signal A_{eR} reflected at the reflector element. It is important for determining the attenuation of the measuring signal that the reflection coefficient of the reflector element is known.

The signal line of the electronic unit via which the generated measuring signal is transmitted can be elongated with a cable, for example with a coaxial cable, for determining αₑ. The attenuation αₑ is determined taking into account the influence of the additional cable on the measuring signal.

In particular, the resistance of the reflector element and/or the impedance of the additional cable and/or the attenuation due to the additional cable is also taken into account.

Particularly preferably, αₑ is determined according to the following formula:

$${α}_{e} = \frac{{A}_{e R}}{{A}_{e S} \cdot {α}_{c a b l e}}$$

wherein A_{eR} is the amplitude of the reflected signal, wherein A_{eS} is the amplitude of the emitted measuring signal, and wherein α_{cable} is the attenuation caused by the cable.

This design has the advantage that the transit time of the reflected pulse can be extended, so that the reflected pulse can be well distinguished from the measuring signal emitted by the electronic unit and, in particular, does not overlap with it.

The attenuation de can be measured during the manufacture or assembly of the measuring transducer. The measured value de is characteristic for the individual measuring transducer and is preferably stored in the electronics unit. According to a next advantageous design, the electronic unit comprises a temperature sensor that captures the temperature of the electronic unit. During the determination of the attenuation of the signal by the electronic unit, the temperature dependence of the attenuation can also be determined.

The mechanical attenuation αₘ corresponds to an average value for the process connection element used.

Such an average value can, for example, be determined in advance for a large number of different process connection elements.

The mechanical attenuation can be determined as follows:

Assuming that the attenuation by the electronic unit generating the signal is known, the process connection element can be short-circuited either in front of or behind the flange in the direction of propagation of the signal. The flange can be a part of the process connection element or can be arranged between the process connection element and the container.

If the process connection element is short-circuited in front of the flange, the attenuation by the process connection element can be determined by capturing a reflected pulse.

If the process connection element is short-circuited behind the flange, the reflection at the interface of the process connection element to the flange is also taken into account. In this case, the mechanical attenuation can be determined according to the following formula:

$${α}_{m} = \frac{{A}_{m R} - {A}_{p a r}}{{A}_{m S} \cdot {α}_{e}}$$

wherein A_{mR} is the amplitude of the signal reflected at the termination element, wherein Aₚₐᵣ is the amplitude of the signal reflected at the interface to the flange, and wherein A_{mS} is the amplitude of the transmitted signal, and wherein αₑ is the known attenuation due to the electronic unit.

A plurality of process interface elements with the same characteristics can be measured and the average value for the signal attenuation αₘ is formed. This average value can be stored in the electronics unit.

Since the attenuation αₘ for different measuring transducers is subject to only minor fluctuations, it is not necessary to determine αₘ individually for each measuring transducer if the mean value of the attenuation αₘ is known.

Further, the following procedure can also be used to determine the attenuation αₘ:

With known αₑ, known process conditions, in particular known fill level and known process temperature, an expected value for αₘ can first be assumed, wherein this expected value is varied during the measurement of the fill level until the actual fill level is measured.

A temperature sensor can be provided which captures the temperature of the process connection element. When determining the mean value for αₘ, the temperature dependence for the attenuation αₘ can then also be determined.

It is also conceivable to use an extension element, for example an extension cable, to determine the mean value αₘ in the same way as the electronic unit determines the attenuation. In this way, the emitted pulse and the reflected pulse can be distinguished particularly well in terms of time.

For example, the process connection element can be designed as a coaxial conductor or a waveguide. Depending on the application, the coaxial conductor can have different dielectrics. The process connection element ensures, in particular thermal, insulation of the electronics unit from the process environment.

For the connection to the container, the process connection element can have a flange.

Thus, a stored value can be used as mechanical attenuation αₘ for different measuring transducers. It is not necessary to measure the value of the mechanical attenuation αₘ separately for individual measuring transducers. The actual deviations from an average value determined for the type of process connection element are so small that they can be neglected.

According to a next advantageous design, the impedance ratio IFR₀=Z_{0_probe}/Z_{MU} is also taken into account for determining the relative permittivity εᵣ of the gaseous medium, wherein Z_{0_probe} is the impedance of the probe in a vacuum and Z_{MU} is the impedance of the measuring transducer.

The impedance ratio IFR₀ can be determined in a reference gas, especially in air. The impedance ratio is also a quantity that is measured individually for each measuring transducer at least once.

If the reference gas is air, the impedance ratio can be determined according to the following relationship:

$${IFR}_{0} = \sqrt{{ε}_{r , air}} \cdot \frac{{α}_{0} + R}{{α}_{0} - R} = \frac{{α}_{0} + R}{{α}_{0} - R}$$

where ε_{r,air} is approximately 1, where α₀ is the attenuation by the measuring transducer, and where R is the reflection coefficient, which is the ratio of the amplitudes of a measuring signal A_{S} emitted by the electronic unit and the amplitude A_{R} of a measuring signal reflected at the interface of the process connection element and the container, i.e.

$$R = \frac{{A}_{R}}{{A}_{S}} .$$

The amplitudes A_{S} and A_{R} can be measured to determine the impedance ratio in air.

Alternatively, the impedance ratio IFR₀ can be determined in a medium other than air, wherein the relative permittivity εᵣ of the medium is known, and wherein the impedance ratio IFR₀ is inferred from the impedance ratio thus determined by appropriate correction.

The impedance ratio IFR₀ can be stored in the electronic unit and used to determine the relative permittivity εᵣ of the gaseous medium. According to this design, it is not necessary to determine the values of the individual impedances Z_{0_probe} and Z_{MU}. Only the impedance ratio IFR₀ is relevant.

According to another preferred design of the method according to the invention, the relative permittivity of the gaseous medium arranged above the process medium in the container is determined by the following formula:

$${ε}_{r} = {( \frac{{Z}_{0 \_ probe}}{{Z}_{MU}} \cdot \frac{{α}_{0} - \frac{{A}_{R}}{{A}_{S}}}{{α}_{0} + \frac{{A}_{R}}{{A}_{S}}} )}^{2} = {( {IFR}_{0} \cdot \frac{{α}_{0} - \frac{{A}_{R}}{{A}_{s}}}{{α}_{0} + \frac{{A}_{R}}{{A}_{S}}} )}^{2}$$

Here, preferably α₀=αₑ·αₘ.

The values αₑ and αₘ or α₀ and IFR₀ can be stored in the electronic unit, so that the relative permittivity εᵣ of the gaseous medium above the process medium can be determined or monitored at regular or irregular intervals, even during measurement operation.

The relative permittivity εᵣ can be determined permanently and taken into account in the level measurement.

If the relative permittivity εᵣ changes during operation of the TDR level measuring device, the propagation speed of the measuring signal moving through the gaseous medium can be adjusted.

Also, another sensor, for example, a temperature sensor, can be provided to measure a process parameter, for example, the temperature, in the container. The relative permittivity εᵣ can be redetermined when the value of the process parameter, for example the temperature, in the container exceeds a predetermined tolerance range.

The method thus has the advantage that the determination of the transit time of the measuring signal can be adapted to changes in process parameters, such as the temperature or even the composition of the gaseous medium, so that the determination of the fill level of the process medium to be monitored is particularly accurate.

At least one temperature sensor can be provided that determines the temperature of the electronic unit and/or the process connection element. For example, one temperature sensor can be provided that determines both the temperature of the electronics unit and the temperature of the process connection element. However, two temperature sensors may also be provided, wherein one temperature sensor determines the temperature of the electronics unit and one temperature sensor determines the temperature of the process connection element.

If at least one such temperature sensor is provided, it is particularly advantageous if the temperature is captured by the electronics unit and/or the process connection element during operation. If the temperature of the electronic unit and/or the process connection element changes, the values for αₑ or αₘ are corrected according to the stored temperature behavior.

In this respect, the total attenuation α₀ also changes in the case of a temperature drift. By adapting the value of the attenuation α₀ to a temperature change, the value of the relative permittivity εᵣ and thus the propagation speed of the measuring signal through the medium can be determined particularly accurately.

According to a second teaching of the present invention, the object set out at the beginning is achieved by a TDR level measuring device described at the beginning in that the electronics unit is designed and set up to perform one of the methods described above. In view of the design of the TDR level measuring device, reference is made to all designs described above.

There are now a large number of possibilities for designing and further developing the method according to the invention and the TDR level measuring device according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a TDR level measuring device,

FIG. 2 shows an example of a setup for determining the attenuation de,

FIG. 3 shows an example of a method for determining the relative permittivity of the gaseous medium, and

FIG. 4 shows an example of the method for determining the fill level of a process medium in a vessel.

### DETAILED DESCRIPTION

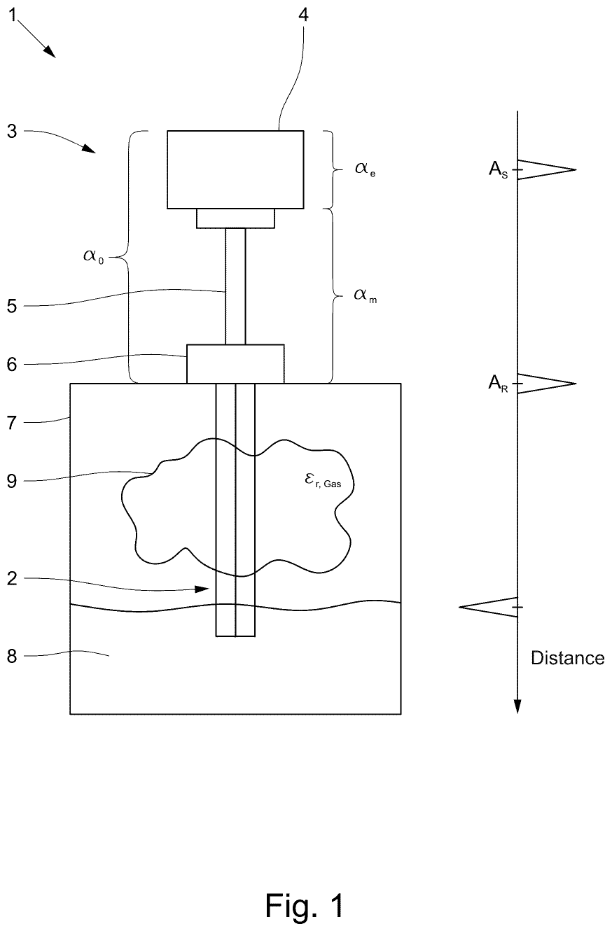

FIG. 1 shows an example of a TDR level measuring device 1 with a probe 2 for guiding an electromagnetic signal and with a measuring transducer 3.

The measuring transducer 3 comprises an electronic unit 4 for generating a measuring signal and for evaluating a reflected measuring signal and a process connection element 5, wherein the measuring transducer 3 is connected to a container 7 via the process connection element 5 with a flange 6.

In the example shown, the process connection element 5 is designed as a waveguide. It is also possible that the process connection element 5 is designed as coaxial conductor.

A process medium 8 is arranged in the container 7, the fill level of which can be determined and/or monitored by the level measuring device 1. To determine the fill level, the level measuring device 1 emits a measuring signal that moves along the probe 2 in the direction of the process medium 8 and is reflected at the interface with the process medium.

From the transit time of the reflected measuring signal, the distance between the flange 6 and the process medium surface and, from this, the fill level of the process medium 8 in the container 7 is determined. In this respect, it is relevant to know the exact propagation speed at which the measuring signal moves along the probe 2.

If the gaseous medium 9 above the process medium 8 is different from air or if the temperature in the container 7 changes, i.e. if the relative permittivity εᵣ is greater than 1, the propagation speed of the measuring signal is reduced.

The electronics unit 4 is therefore designed and arranged to determine the relative permittivity εᵣ of the gaseous medium arranged in the vessel 7 above the process medium.

During operation, the electronics unit 4 determines the relative permittivity εᵣ from the measured ratio of the amplitude A_{S} of a measuring signal emitted by the electronics unit 4 and the amplitude A_{R} of a measuring signal reflected at the interface of the process connection element and the container 7.

Furthermore, the electronics unit 4 takes into account the attenuation α₀ of the measuring signal in the area of the measuring transducer 3 and the impedance ratio IFR₀ of the impedance of the probe Z_{0_probe} and the impedance of the measuring transducer Z_{MU}.

The impedance ratio IFR₀ has been determined for the TDR level measuring device shown in an empty container 7, i.e. in air, and stored in the electronics unit 4.

The attenuation α₀ is composed of the attenuation αₑ by the electronics unit 4 and the mechanical attenuation αₘ by the process connection element 5.

To determine the attenuation α₀, the attenuation αₑ by the electronic unit 4 was measured during the manufacture, i.e. the assembly, of the measuring transducer 3. The value of the mechanical attenuation αₘ is well known for the process connection element 5 used and corresponds to an average value for the type of process connection element shown.

The value of the attenuation α₀ determined in this way is stored in the electronics unit 4 in the example shown.

In this respect, the illustrated TDR level measuring device 1 can determine the current permittivity εᵣ permanently or at regular or irregular intervals during operation and take it into account in the level calculation.

As a result, the TDR level measuring device thus exhibits particularly high accuracy.

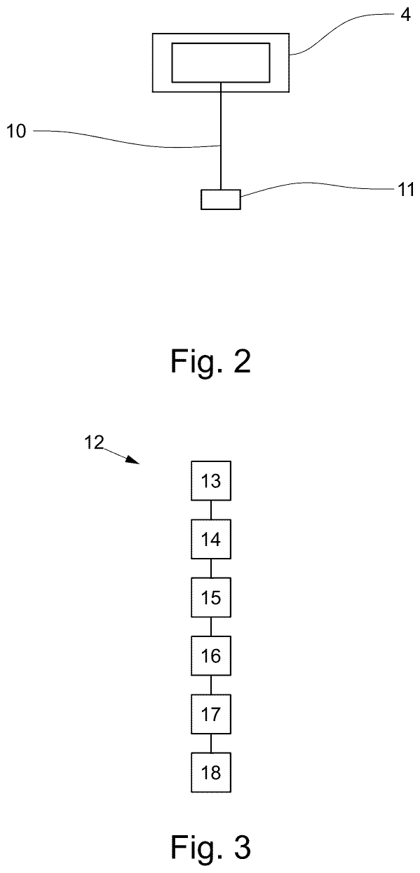

FIG. 2 shows a setup for measuring the attenuation αₑ by the electronics unit 4. The electronics unit 4 is connected to a cable 10 for elongating the measuring section. A reflection element 11 with a known reflection factor is arranged at the end of the cable 10. Such an elongation has the advantage that the reflected pulse can be better distinguished from the emitted measuring signal due to a longer transit time.

From the measurement of the amplitude A_{S} of the emitted measuring signal and the measurement of the amplitude A_{R} of the measuring signal reflected at the end of the cable 10, the attenuation de can be determined, taking into account the influence of the cable 10.

FIG. 3 shows an example of a method 12 for operating a TDR level measuring device 1.

In a first step 13, the attenuation de is determined by the electronic unit 4 as described above and stored in the electronic unit 4.

In a next step 14, the attenuation αₘ caused by the process connection element 5 is determined. The value of the attenuation αₘ corresponds to an average value recorded in preparatory steps for a plurality of different process connection elements.

The attenuation α₀ in the measuring transducer is determined from the attenuation αₑ and αₘ values by multiplication in step 15.

After the transducer 3 is fully assembled and the level measuring device 1 is placed on a container 7, the impedance ratio IFR₀ is determined in step 16, wherein the container 7 is empty and thus the gaseous medium 9 surrounding the probe 2 is air with a permittivity εᵣ approximately 1.

The impedance ratio IFR₀ determined in this manner is likewise stored in the electronics unit 4.

During operation of the TDR level measuring device 1, the relative permittivity εᵣ of the gaseous medium 9 arranged above the process medium 8 can now be determined based on the previously determined and stored values.

For this, the amplitude A_{S} of a measuring signal generated by the electronic unit 4 and the amplitude A_{R} of a measuring signal reflected at the interface to the container 7 are captured in step 17.

From the stored attenuation α₀, the stored impedance ratio IFR₀ and the measured amplitude ratio A_{R}/A_{S}, the relative permittivity εᵣ of the gaseous medium 9 above the process medium 8 can be determined in a next step 18.

The determined permittivity εᵣ is taken into account in the transit time determination and to that extent in the level determination.

The method 12 shown has the advantage that changes in process conditions which affect the speed of propagation of the measuring signal in the container 7 are taken into account, so that the overall accuracy of the level determination can be improved.

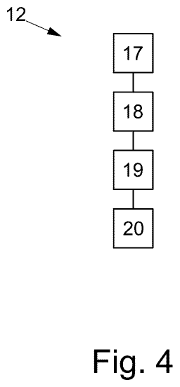

FIG. 4 shows an example of a method 12 for determining the fill level taking into account the determination of the relative permittivity εᵣ.

In a first step 17, the amplitude ratio A_{R}/A_{S} of a measuring signal reflected at the transition to the container 7 and a measuring signal generated by the electronic unit 4 is determined.

From the amplitude ratio and the stored values for the attenuation α₀ in the measuring transducer and the impedance ratio IFR₀, the value of the relative permittivity εᵣ of the gaseous medium above the process medium is determined in step 18.

Subsequently, the transit time of the measuring signal reflected at the surface of the process medium is determined in step 19 taking into account the determined relative permittivity of the gaseous medium.

From the measured transit time, the fill level of the process medium 8 is determined in a next step 20.

Due to the consideration of the current relative permittivity εᵣ of the gaseous medium above the process medium, the method shown has a particularly high accuracy.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a TDR level measuring device, the TDR level measuring device comprising at least one probe to guide an electromagnetic signal and a measuring transducer, the measuring transducer comprising an electronic unit to generate a measuring signal and to evaluate a reflected measuring signal and a process connection element, the method comprising:
connecting the measuring transducer to a container via the process connection element;
arranging process medium to be measured in the container;
arranging a gaseous medium above the process medium;
determining a relative permittivity εᵣ of the gaseous medium by capturing and evaluating an amplitude A_{S} of a measuring signal emitted by the electronic unit and an amplitude A_{R} of a measuring signal reflected at an interface of the process connection element and the container; and
taking into account, in order to determine the relative permittivity εᵣ, an attenuation Co of the emitted measuring signal by the measuring transducer,
wherein, in order to determine the attenuation α₀, the attenuation αₑ by the electronics unit and the mechanical attenuation αₘ by the process connection element are determined, and/or
wherein, in order to determine the relative permittivity εᵣ, an impedance ratio IFR₀=Z_{0_probe}/Z_{MU} is taken into account,
wherein Z_{0_probe} is an impedance of the probe in a vacuum and Z_{MU} is an impedance of the measuring transducer, and
wherein the impedance ratio IFR₀ is determined in a reference gas with known permittivity εᵣ.

2. The method according to claim 1, wherein the attenuation αₑ of the measuring transducer is measured, wherein a reflector is placed at an output of the electronic unit to measure the attenuation αₑ and wherein αₑ is determined by comparing the amplitude of a measuring signal A_{eS} emitted by the electronic unit and a measuring signal A_{eR} reflected at the reflector.

3. The method according to claim 1, wherein the signal line of the electronic unit, via which the generated measuring signal is transmitted, is extended with a cable or a coaxial cable for the determination of αₑ, and wherein the attenuation αₑ is determined, taking into account the attenuation of the measuring signal, by the additional cable.

4. The method according to claim 1, wherein the determination of αₑ is carried out during an assembly of the measuring transducer.

5. The method according to claim 1, wherein the attenuation αₘ corresponds to an average value for the process connection element used.

6. The method according to claim 1, wherein the impedance ratio IFR₀ is determined in air.

7. The method according to claim 1, wherein the impedance ratio IFR₀ is determined in a medium other than air, wherein the relative permittivity εᵣ of the medium is known, and wherein the impedance ratio IFR₀ is inferred from the impedance ratio thus determined by appropriate correction.

8. The method according to claim 1, wherein the relative permittivity εᵣ of the gaseous medium is determined according to the following formula:
$${ε}_{r} = {( \frac{{Z}_{0 \_ probe}}{{Z}_{MU}} \cdot \frac{{α}_{0} - \frac{{A}_{R}}{{A}_{S}}}{{α}_{0} + \frac{{A}_{R}}{{A}_{S}}} )}^{2} = {( {IFR}_{0} \cdot \frac{{α}_{0} - \frac{{A}_{R}}{{A}_{s}}}{{α}_{0} + \frac{{A}_{R}}{{A}_{S}}} )}^{2}$$

9. The method according to claim 8, wherein in the determination of the relative permittivity εᵣ the attenuation is α₀=αₑ·αₘ.

10. The method according to claim 1, wherein the determined relative permittivity εᵣ is taken into account in the evaluation of the transit time of a measuring signal reflected at a surface of the process medium.

11. The method according to claim 1, wherein the relative permittivity εᵣ is redetermined at regular or irregular intervals by measuring the amplitude ratio A_{R}/A_{S}.

12. The method according to claim 1, wherein the temperature of the electronics unit and/or of the process connection element is also taken into account when determining the relative permittivity εᵣ, and wherein a value of the attenuation α₀ is adjusted in the event of a change in the temperature of the electronics unit and/or of the process connection element.

13. A TDR level measuring device comprising:
at least one probe to guide an electromagnetic signal;
a measuring transducer that comprises an electronic unit to generate a measuring signal and to evaluate a reflected measuring signal; and
a process connection element,
wherein the measuring transducer is connectable to a container via the process connection element, and
wherein the electronic unit is designed and set up to perform the method according to claim 1.
